(19) United States
(12) Patent Application Publication
(10) Pub. No.: US 2006/0250520 A1
(43) Pub. Date: Nov. 9, 2006

(54) Video coding method and apparatus for reducing mismatch between encoder and decoder

(75) Inventors: Woo-Jin Han, Suwon-si (KR); Bae-Keun Lee, Bucheon-so (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/402,842

(22) Filed: Apr. 13, 2006

Related U.S. Application Data
(60) Provisional application No. 60/670,702, filed on Apr. 13, 2005.

(30) Foreign Application Priority Data
Jun. 17, 2005 (KR) 10-2005-0052425

(51) Int. Cl. H04N 11/02

(52) U.S. Cl. 348/398.1

(57) ABSTRACT

A method of reducing a mismatch between an encoder and a decoder in motion compensated temporal filtering, and a video coding method and apparatus using the same. The video coding method includes dividing input frames into one final low-frequency frame and at least one high-frequency frame by performing motion compensated temporal filtering on the input frames; encoding the final low-frequency frame and decoding the encoded final low-frequency frame; re-estimating the at least one high-frequency frame using the decoded final low-frequency frame; and encoding the re-estimated high-frequency frame.

### CROSS-REFERENCE TO RELATED APPLICATIONS

This application claims priority from Korean Patent Application No. 10-2005-0052425 filed on Jun. 17, 2005 in the Korean Intellectual Property Office, and U.S. Provisional Patent Application No. 60/670,702 filed on Apr. 13, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate generally to video coding, and more particularly, to reducing a mismatch between an encoder and a decoder in motion compensated temporal filtering.

2. Description of the Prior Art

As information and communication technology, including the Internet, develops, image-based communication, text-based communication, and voice-based communication are increasing. The existing text-based communication is insufficient to satisfy consumers' various demands. Therefore, the provision of multimedia services capable of accommodating various types of information, such as text, images and music, is increasing. Since multimedia data is large, it requires high-capacity storage media and broad bandwidth at the time of transmission. Therefore, to transmit multimedia data, including text, images and audio, the use of a compression coding technique is essential.

The fundamental principle of data compression is to eliminate redundancy in data. Data can be compressed by eliminating spatial redundancy such as the repetition of a color or object in an image, temporal redundancy such as the case where there is little change between neighboring frames or a sound is repeated, or psychovisual redundancy which takes into account human visual and perceptual insensitivity to high frequencies. In a general coding method, temporal redundancy is eliminated using temporal filtering based on motion compensation, and spatial redundancy is eliminated using a spatial transform.

In order to transmit multimedia data after the redundancy has been removed, transmission media are necessary. Performance differs according to transmission medium. Currently used transmission media have various transmission speeds ranging from the speed of an ultra high-speed communication network, which can transmit data at a transmission rate of several tens of megabits per second, to the speed of a mobile communication network, which can transmit data at a transmission rate of 384 Kbits per second. In these environments, a scalable video encoding method is required that can support transmission media having a variety of speeds and that can transmit multimedia at a transmission speed suitable for each transmission environment.

Such a scalable video coding method refers to a coding method that allows a video resolution, a frame rate, a Signal-to-Noise Ratio (SNR), and other parameters to be adjusted by truncating part of an already compressed bitstream in conformity with surrounding conditions, such as the transmission bit rate, transmission error rate, system source, and others.

Motion Compensated Temporal Filtering (MCTF) is widely used in scalable video coding methods that support temporal scalability, such as the H.264 Scalable Extension (SE). In particular, 5/3 MCTF, which uses both neighboring right-hand and left-hand frames, has not only a high compression efficiency, but also a structure suitable for temporal scalability and SNR scalability. Therefore, 5/3 MCTF has been adopted in the working draft of H.264 SE that is being standardized by the Moving Pictures Expert Group (MPEG).

FIG. 1 shows the structure of 5/3 MCTF, which sequentially performs a prediction step and an update step on one Group of Pictures (GOP).

As shown in FIG. 1, in the MCTF structure, a prediction step and an update step are repeatedly performed in temporal level order. A frame generated by the prediction step is referred to as a high-frequency frame (indicated by “H”) and a frame generated by the update step is referred to as a low-frequency frame (indicated by “L”). The prediction step and the update step are repeated until one low-frequency frame L(4) is produced.

FIG. 2 is a view generally showing a prediction step and an update step. In FIG. 2, subscripts “t” and “t+1” indicate a temporal level t and a temporal level t+1, respectively, and the “−1”, “0” and “1” in parentheses indicate the temporal order. The numbers on each arrow indicate the weight ratio of each frame in the prediction step or the update step.

In the prediction step, a high-frequency frame H(0) is acquired using a difference between a current frame Lₜ(0) and a frame that is predicted from neighboring right-hand and left-hand reference frames Lₜ(−1) and Lₜ(1). In the update step, the neighboring right-hand and left-hand reference frames Lₜ(−1) and Lₜ(1) that are used in the previous prediction step are changed using the frame H(0) generated in the prediction step. This is a process of eliminating high-frequency components, that is, the frame H(0), from a reference frame, and it is similar to a type of low-frequency filtering. Since these changed frames Lₜ₊₁(−1) and Lₜ₊₁(1) are free of high-frequency components, efficiency can be improved at the time of compression.

In MCTF, the respective frames of a GOP are arranged on a temporal level basis, and one H frame (a high-frequency frame) is produced by performing the prediction step for each temporal level, and two reference frames used in the prediction step are changed using the H frame (the update step). If this process is performed on N frames at one temporal level, N/2 H frames and N/2 L frames (low-frequency frames) can be obtained. As a result, if this process is performed until only a final L frame (refers to a low-frequency frame) remains, M-1H frames and one L frame remain when the number of frames of one GOP is set to M. Thereafter, the encoding process can be finished by quantizing these frames.

In more detail, in the prediction step, motion estimation is performed on neighboring right-hand and left-hand frames to obtain an optimal block, as shown in FIG. 2, and an optimal prediction block is generated based on this block. If the difference between this block and the block of an original frame is obtained, blocks included in the H frame can be obtained. In FIG. 2, “−½” indicates the case where bidirectional predictions, that is, both frames, are used. If only the left-hand reference frame or the right-hand reference frame is used, as necessary, “−1” indicates this.

The update step functions to eliminate the high-frequency components of the right-hand and left-hand reference frames using a difference image obtained in the prediction step, that is, the H frame. As shown in FIG. 2, Lₜ(−1) and Lₜ(1) are changed to Lₜ₊₁(−1) and Lₜ₊₁(1), from which the high-frequency components are eliminated during the update step.

One of the significant differences between MCTF having the above-described structure and an existing compression method, such as MPEG-4 or H.264, is that the MCTF has a codec configuration having an open-loop structure and adopts the update step in order to reduce the drifting error. The open-loop structure refers to a structure employing right-hand and left-hand reference frames that are not quantized in order to obtain a difference image (high-frequency frame). An existing video codec generally uses a process (including a quantization process) that encodes and restores a preceding reference frame and then uses the results thereof, that is, a closed-loop structure.

It is known that the performance of the MCTF-based open-loop codec is superior to that of the closed-loop structure in the situation where SNR scalability is applied, that is, the situation where a difference in the picture quality between a reference frame used in an encoder and a reference frame used in a decoder may occur. However, in the open-loop structure, the reference frame used in the encoder and the reference frame used in the decoder are not the same, and therefore it is difficult to solve the problem where severe drift error is generated as compared to that of the closed-loop process. In order to mitigate this problem, MCTF has an update step that is capable of eliminating the high-frequency components that a difference image has from an L frame at the next temporal level. Therefore, not only can compression efficiency be increased, but the error accumulation effect (that is, drift error accumulation) in the open-loop structure can be also reduced. Although drift error can be reduced using the update step, the mismatch between the encoder and the decoder cannot be fundamentally eliminated compared to the closed-loop. Therefore, a decrease in performance is inevitable.

The MCTF-based codec mainly has two types of mismatches between the encoder and the decoder. The first is a mismatch in the prediction step. Referring to the prediction step of FIG. 2, the right-hand and left-hand reference frames are used to produce the H frame. However, since the right-hand and left-hand reference frames have not yet been quantized, the decoder cannot recognize that the H frame produced in this manner is an optimal signal. Only after the right-hand and left-hand reference frames are changed by the update step, and then changed to the H frame in the temporal level can they be quantized. It is difficult in the MCTF structure to consider the previous quantization of the reference frames, as is done in the closed-loop process.

The second mismatch occurs in the update step. Referring to the update step of FIG. 2, the high-frequency frame H(0) is used to change the right-hand and left-hand reference frames Lₜ(−1) and Lₜ(1). Since the high-frequency frame has not yet been quantized, the mismatch between the decoder and the encoder occurs even in this case.

The present invention proposes, after the completion of MCTF, a process of re-calculating the H frame (hereinafter referred to as “frame re-estimation”) including a coding/decoding process in order to solve the mismatch in the prediction step. The present invention also proposes a method that is capable of reducing a mismatch between the encoder and the decoder by performing an update step using re-estimated images neighboring an encoded/decoded difference image, instead of the H frame (that is, an original difference image), hereinafter referred to as a “closed-loop update”, in order to solve the mismatch in the update step.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a method and apparatus for improving overall video compression efficiency by reducing drift error between an encoder and a decoder in an MCTF-based video codec.

The present invention also provides a method and apparatus for efficiently re-estimating a high-frequency frame in an MCTF-based video codec.

The present invention also provides a method and apparatus for efficiently performing an update step at a current layer using the lower layer information in an MCTF-based multi-layered video codec.

According to an aspect of the present invention, there is provided a video encoding method including dividing input frames into one final low-frequency frame and one or more high-frequency frames by performing motion compensated temporal filtering on the input frames; encoding the final low-frequency frame and then decoding the encoded final low-frequency frame; re-estimating the high-frequency frames using the decoded final low-frequency frame; and encoding the re-estimated high-frequency frames.

According to another aspect of the present invention, there is provided a video encoding method including dividing input frames into one final low-frequency frame and one or more high-frequency frames by performing motion compensated temporal filtering on the input frames; and encoding the final low-frequency frame and the high-frequency frames; wherein the dividing input frames includes generating the high-frequency frames from a low-frequency frame of a current layer; generating a virtual high-frequency frame using a restored frame of a lower layer; and updating the low-frequency frame using the virtual high-frequency frame.

According to another aspect of the present invention, there is provided a video encoding method, including dividing input frames into one final low-frequency frame and one or more high-frequency frames by performing motion compensated temporal filtering on the input frames; and encoding the final low-frequency frame and the high-frequency frames; wherein the dividing the input frames includes generating the high-frequency frames from a low-frequency frame of a current layer; generating a virtual high-frequency frame using a restored frame of a lower layer; and updating the low-frequency frame using a weighted mean of the high-frequency frames and the virtual high-frequency frame.

According to another aspect of the present invention, there is provided a video decoding method including restoring a final low-frequency frame and one or more high-frequency frames by decoding texture data included in an input bitstream; and performing inverse-motion compensated temporal filtering on the final low-frequency frame and the high-frequency frames using motion data included in the input bitstream; wherein the high-frequency frames are high-frequency frames re-estimated in an encoder.

According to another aspect of the present invention, there is provided a video decoding method including restoring a final low-frequency frame and one or more high-frequency frames of a current layer by decoding texture data included in an input bitstream; and performing inverse-motion compensated temporal filtering on the final low-frequency frame and the high-frequency frames using motion data included in the input bitstream; wherein the performing inverse-motion compensated temporal filtering includes generating a virtual high-frequency frame using a restored frame of a lower layer; inversely updating a first low-frequency frame using the virtual high-frequency frame; and restoring a second low-frequency frame by inversely predicting the restored high-frequency frame with reference to the updated first low-frequency frame.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a diagram showing the structure of 5/3 MCTF, which sequentially performs a prediction step and an update step on one GOP;

FIG. 2 is a view generally showing the prediction step and the update step;

FIG. 3 is a view illustrating the 5/3 MCTF process;

FIG. 4 is a view illustrating a closed-loop frame re-estimation process based on mode 0;

FIG. 5 is a view illustrating a decoding process based on mode 0;

FIG. 6 is a view illustrating an MCTF process based on mode 1;

FIG. 7 is a view illustrating a closed-loop frame re-estimation process based on mode 1;

FIG. 8 is a view illustrating a decoding process based on mode 1;

FIG. 9 is a view illustrating an MCTF process based on mode 2;

FIG. 10 is a view illustrating a decoding process based on mode 2;

FIG. 11 is a block diagram of a video encoder based on mode 0 according to an exemplary embodiment of the present invention;

FIG. 12 is a block diagram of a video encoder based on mode 2 according to an exemplary embodiment of the present invention;

FIG. 13 is a block diagram of a video decoder based on mode 0 according to an exemplary embodiment of the present invention;

FIG. 14 is a block diagram of a video decoder based on mode 2 according to an exemplary embodiment of the present invention; and

FIG. 15 is a diagram illustrating a system for performing the operation of a video encoder or a video decoder according to an exemplary embodiment of the present invention.

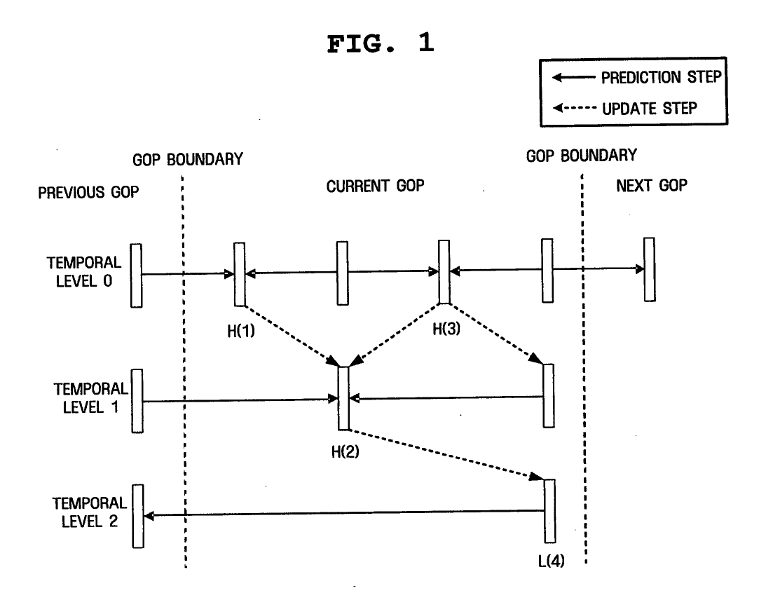

### DETAILED DESCRIPTION OF THE EXEMPLARY EMBODIMENTS

The present invention will now be described in detail in connection with exemplary embodiments with reference to the accompanying drawings.

A “closed-loop frame re-estimation method” proposed by the present invention is performed using the following processes.

First, when the size of a GOP is M after the existing MCTF has been performed, M−1 H frames and one L frame are obtained.

Second, an environment is conformed to that of a decoder by coding/decoding right-hand and left-hand reference frames while performing MCTF in an inverse manner.

Third, a high-frequency frame is recalculated using the encoded/decoded reference frames.

Furthermore, a method of implementing a “closed-loop update”, which is proposed by the present invention, includes the following three modes.

Mode 1 involves reducing a mismatch by omitting an update step for the final L frame

Mode 2 involves replacing an H frame used in the update step with the information of a base layer

Mode 3 involves reducing a mismatch using the weighted mean of an existing H frame and information obtained in mode 2.

The closed-loop frame re-estimation technique and the closed-loop update technique according to the present invention can be applied together or independently. The closed-loop frame re-estimation technique will be first described below.

Closed-Loop Frame Re-Estimation

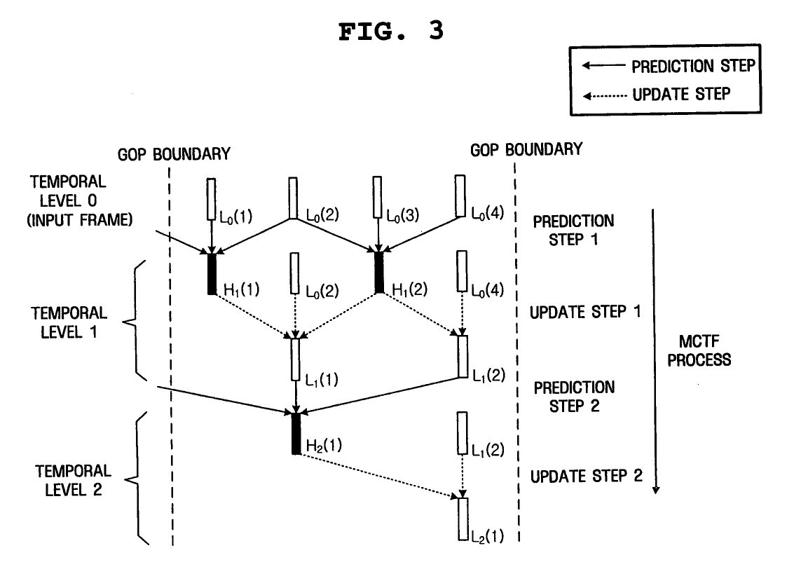

FIG. 3 is a view illustrating the 5/3 MCTF process. As shown in FIG. 3, if MCTF is performed according to an existing method, one L frame and a plurality of H frames are obtained.

A general MCTF process is performed based on a lifting scheme. The lifting scheme includes a prediction step and an update step. The lifting scheme divides input frames into frames that will undergo low-frequency filtering (hereinafter referred to as L location frames) and frames that will undergo high-frequency filtering (hereinafter referred to as H location frames), and then applies the prediction step to the H location frames while consulting neighboring frames, thus generating H frames. The update step is then applied to the L location frames using the generated H location frames, thus generating L frames.

The following Equation 1 expresses the prediction step and the update step in mathematical form.

$${H}_{t + 1} ( k ) = {L}_{t} ( 2 k - 1 ) - P ( {L}_{t} ( 2 k - 1 ) ) with \\ P ( {L}_{t} ( 2 k - 1 ) ) = {\sum }_{i} {p}_{i} {L}_{t} ( 2 ( k + i ) ) \\ {L}_{t + 1} ( k ) = {L}_{t} ( 2 k ) + U ( {H}_{t + 1} ( k ) ) with \\ U ( {H}_{t + 1} ( k ) ) = {\sum }_{i} {u}_{i} {H}_{t + 1} ( k + i ) ; \qquad ( 1 )$$

where Lₜ( . . . ) indicates L frames generated at a temporal level t. However, Lₜ( . . . ) where t=0, that is, L₀( . . . ), indicates original input frames. Furthermore, Hₜ₊₁( . . . ) indicates H frames generated at a temporal level t+1, and Lₜ₊₁( . . . ) indicates L frames generated at a temporal level t. The constant within the parentheses is an index indicating the order of frames. In addition, Pᵢ and uᵢ are constant coefficients. If a Haar filter is used in the MCTF process, P(Lₜ (2k−1)) and U(Hₜ₊₁(k)) of Equation 1 can be expressed by the following Equation 2.

$$P ( {L}_{t} ( 2 k - 1 ) ) = {L}_{t} ( 2 k ) \\ U ( {H}_{t + 1} ( k ) ) = \frac{1}{2} {H}_{t + 1} ( k ) \qquad ( 2 )$$

Furthermore, if a 5/3 filter is used in the MCTF process, P(Lₜ(2k−1)) and U(Hₜ₊₁(k)) of Equation 1 can be expressed by the following Equation 3.

$$P ( {L}_{t} ( 2 k - 1 ) ) = \frac{1}{2} ( {L}_{t} ( 2 k - 2 ) + ( {L}_{t} ( 2 k ) ) \\ U ( {H}_{t + 1} ( k ) ) = \frac{1}{4} ( {H}_{t + 1} ( k ) + {H}_{t + 1} ( k - 1 ) ) \qquad ( 3 )$$

These prediction and update steps can be repeatedly performed until one L frame remains. In the case of FIG. 3, one L frame L₂ (1) and three H frames H₁(1), H₁(2), H₂(1) are generated.

Thereafter, the L frame L₂(1) is encoded and decoded. The coding process may include a transform process and a quantization process. The decoding process can include an inverse quantization process and an inverse transform process. The decoded L frame L₂(1) can be represented as L₂′(1). Hereinafter, in the present specification, the encoding process and the decoding process may be collectively referred to as a “restoration process”.

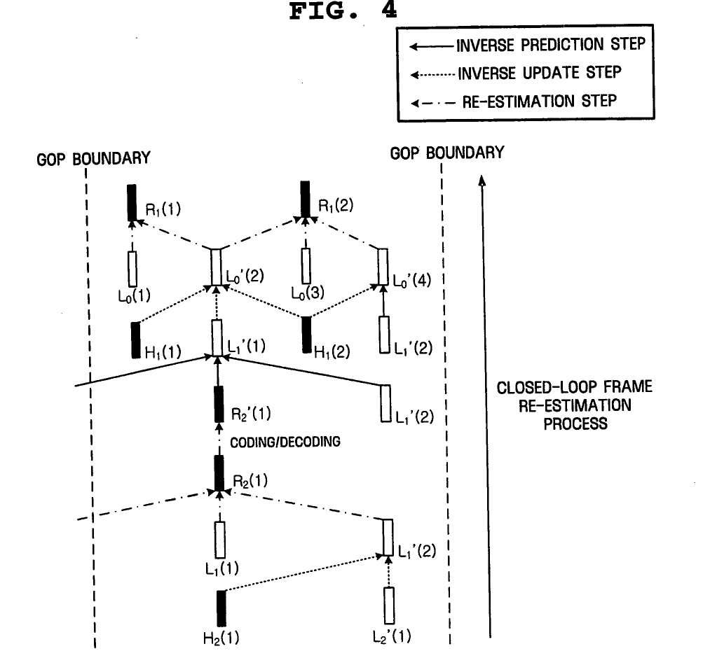

The closed-loop frame re-estimation process using L₂′(1) will be described with reference to FIG. 4. In order to re-estimate H₂(1) using L₂′(1), L₁′(2) must be restored by applying the inverse update step to L₂′(1).

The inverse update step is the inverse of the update step. The inverse update step can be expressed mathematically by the following Equation 4, which is a modification of the second equation of Equation 1.

$${L}_{t} ( 2 k ) = {L}_{t + 1} ( k ) - U ( {H}_{t + 1} ( k ) ) with \\ U ( {H}_{t + 1} ( k ) ) = {\sum }_{i} {u}_{i} {H}_{t + 1} ( k + i ) \qquad ( 4 )$$

For example, Lₜ₊₁(k) corresponds to L₂′(1) of FIG. 4 and Lₜ(2k) corresponds to L₁′(2) of FIG. 4. However, in order to obtain Lₜ(2k), Hₜ₊₁(k) must be known. Since the H frames other than one L frame have not undergone the restoration process, not the H frame that has undergone the restoration process, but an original H frame is used as Hₜ₊₁(k).

In the example of FIG. 4, assuming that Lₜ₊₁(k) is L₂′(1), Hₜ₊₁(k) corresponds to H₂(1). H₂(1) is one of the H frames generated in the MCTF process of FIG. 3. Once Lₜ(2k) is obtained, P(Lₜ(2k−1)) (that is, a predicted frame) can be obtained using Lₜ(2k), as in Equation 5. Hₜ₊₁(k) can be re-estimated by subtracting P(Lₜ(2k−1)) from the original frame Lₒ(2k−1). The re-estimated Hₜ₊₁(k) is represented as Rₜ₊₁(k).

$${R}_{t + 1} ( k ) = {L}_{t} ( 2 k - 1 ) - P ( {L}_{t} ( 2 k - 1 ) ) with \\ P ( {L}_{t} ( 2 k - 1 ) ) = {\sum }_{i} {p}_{i} {L}_{t}^{′} ( 2 ( k + i ) ) \qquad ( 5 )$$

Through the process of Equation 5, a frame R₂(1), which is obtained by re-estimating H₂(1) can be generated from L₀(2) and L₁′(2). R₂(1) becomes R₂′(1) through the restoration process, that is, the closed-loop process, so that it can be used to restore other frames. L₁′(1) can be restored from R₂′(1) and L₁′(2) through the inverse prediction process detailed in the following Equation 6.

$${L}_{t} ( 2 k - 1 ) = {R}_{t + 1}^{′} ( k ) + P ( {L}_{t} ( 2 k - 1 ) ) with \\ P ( {L}_{t} ( 2 k - 1 ) ) = {\sum }_{i} {p}_{i} {L}_{t}^{′} ( 2 ( k + i ) ) ; \qquad ( 6 )$$

where L₁′(1) corresponds to Lₜ(2k−1) and R₂′(1) corresponds to Rₜ₊₁′(k). In addition, P(Lₜ(2k−1)) corresponds to P(L₁(1)), and is a predicted frame which is obtained from L₁′(2) (or L′₁(2) and any L frame of a previous GOP). If L₁′(1) is obtained, L₀′(2) can be restored by applying H₁(1) and H₁(2) to the inverse prediction process, as shown in Equation 4. In a similar way, L₀′(4) can be restored by applying L₁′(2) and H₁(2) to Equation 4.

R₁(1), that is, a re-estimated frame for H₁(1), can be re-estimated by applying L₀(1) and L₀′(2), that is, original frames, to Equation 5. R₁(2), that is, a re-estimated frame for H₁(2), can be re-estimated by applying L₀(3), L₀′(2) and L₀′(4), that is, original frames, to Equation 5.

Since decoded/coded values for a previous GOP can be obtained regardless of the temporal level in FIG. 4, a case where reference is made beyond the left-hand boundary of the GOP is not problematic. Furthermore, although, in FIGS. 3 and 4, one GOP has been described as having four frames, and two temporal levels have been described, this is only illustrative. Accordingly, one GOP may include a different number of frames and a different number of temporal levels.

The re-estimated H frames (hereinafter referred to as “R frames”), such as R₁(1), R₁(2) and R₂(1), are frames that correspond to the H frames that are actually restored in the decoder. Therefore, under the assumption that an effect obtained by a mismatch of the update step is not taken into consideration, a mismatch between the encoder and the decoder is eliminated.

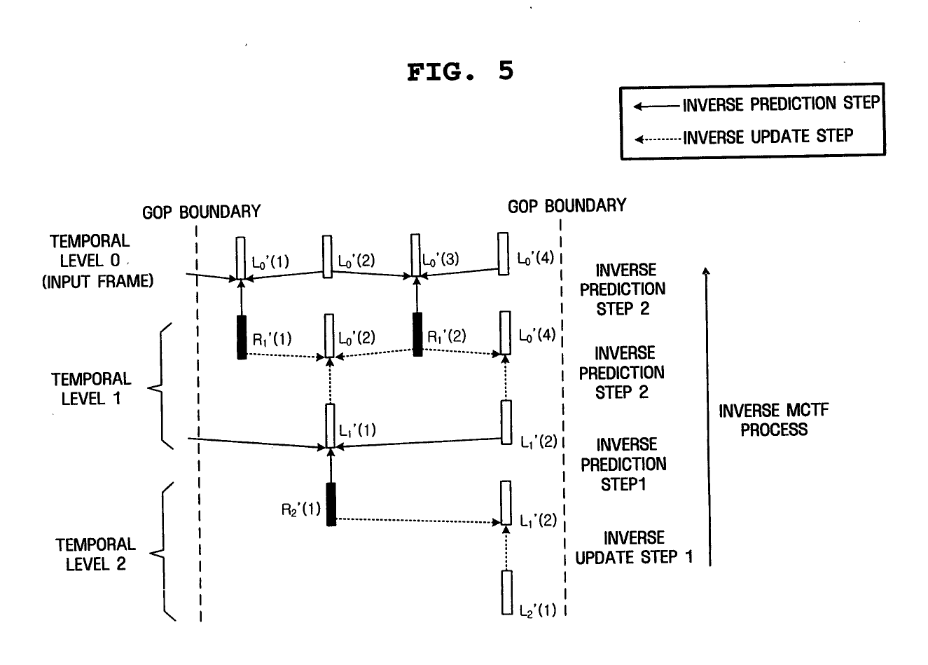

The R frames and the final L frame are encoded and then transmitted to the decoder. The decoder restores video frames using the transmitted frames. Such a restoration process is shown in FIG. 5. As shown in FIG. 5, the original input frames of a temporal level 0 can be restored by a process of repeatedly performing the inverse update step and the inverse prediction step, that is, the inverse MCTF process. The inverse MCTF process can be performed in the same manner as the conventional inverse MCTF process, but it is different from the conventional inverse MCTF process in that the R frames are used instead of the H frames in the inverse prediction step.

Even though the above-described closed-loop frame re-estimation method (hereinafter referred to as “mode 0”) may be effective in eliminating the mismatch between the encoder and the decoder that is caused by the prediction step, the mismatch between the encoder and the decoder that is caused by the update step still exists. Therefore, in the following “closed-loop update step”, a method of eliminating the mismatch between the encoder and the decoder by constructing the update step so that it uses the closed-loop process will be described.

Closed-Loop Update Step

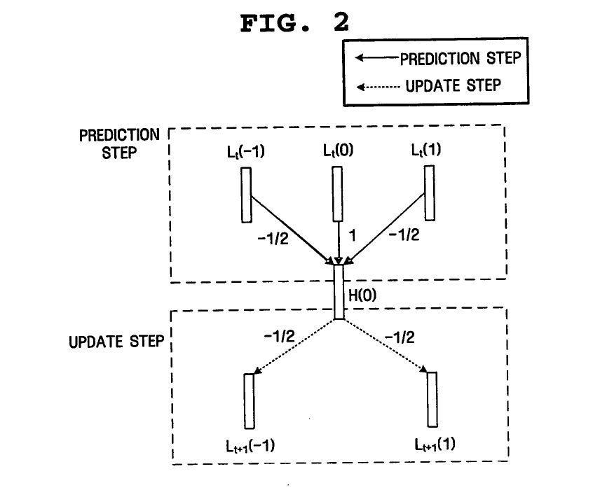

In the update step of the conventional MCTF process, which is shown in FIG. 2, Lₜ(−1) and Lₜ(1) are changed to Lₜ₊₁(−1) and Lₜ₊₁(1) using H(0). From the point of view of the decoder, MCTF is performed in an inverse manner, so that Lₜ₊₁(−1) and Lₜ₊₁(1) are changed to Lₜ(−1) and Lₜ(1) using the restored H′(0). In the conventional MCTF-based encoder, a non-restored H(0) is used, and to discriminate, the result that is obtained by performing the restoration process on H(O) is indicated by H′(0).

There is a problem in that, in the encoder, the unquantized signal H(0) is used, whereas in the decoder, a quantized signal H′(0) is used. In order to solve this problem, the present invention adds several new update steps to reduce a mismatch in the update step. Since forward MCTF is used in the encoder, a quantized H′(0) cannot be obtained. Therefore, the update step that is problematic is omitted, or lower layer information that has already been quantized is used.

The method of omitting the update step for the final L frame (hereinafter referred to as “mode 1”) will be described first. If the proposed closed-loop frame re-estimation method (mode 0) is used, a mismatch will not occur in the update step that has been applied to the H frame location because the H frames are re-estimated and then encoded. However, since the final L frame (L₂(1) in FIG. 3) is not re-calculated, the mismatch between the encoder and the decoder inevitably occurs even if many bits are allocated thereto. This is because the L frames to which the update steps have already been applied cannot be restored to original frames.

To solve this problem, the present invention proposes a method of obviating a mismatch in all the frames (mode 1 to mode 3) in such a way as to use the closed-loop frame re-estimation method, but to omit the update step for a frame that is located at an L frame position.

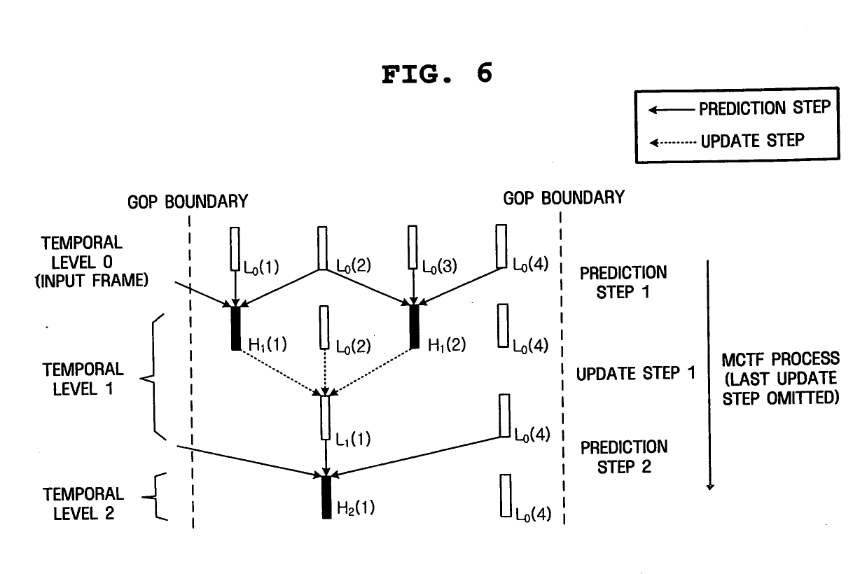

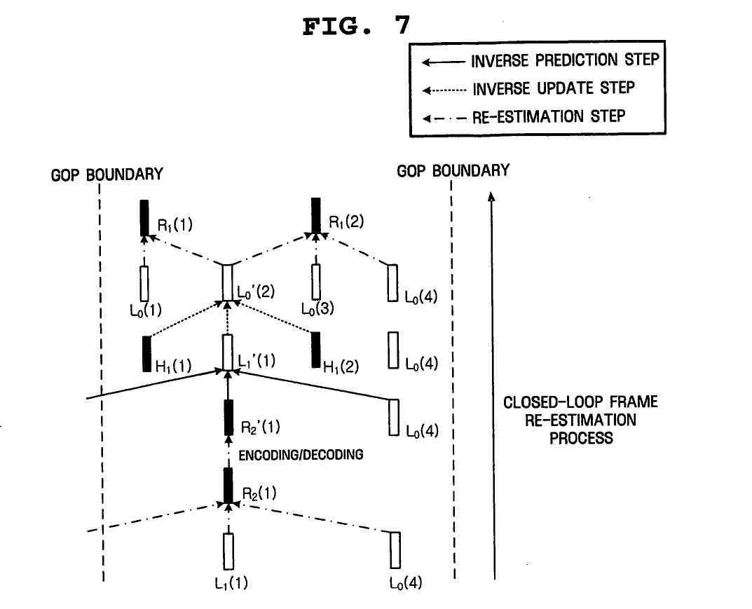

The MCTF process and the closed-loop frame re-estimation process in accordance with mode 1 are illustrated as shown in FIGS. 6 and 7. In the MCTF process of FIG. 6, the process of generating L₁(2) by applying the update step to L₀(4) in the update step 1 of FIG. 3, and the process of generating L₂(1) by applying the update step to L₁(2) in the update step 2 of FIG. 3 are omitted. Furthermore, in the closed-loop frame re-estimation process of FIG. 7, the inverse update process of generating L₁′(2) based on H₂(1) and L₂′(1) and the inverse update process of generating L₀′(4) based on H₁(2) and L₁′(2) in FIG. 4 are omitted.

Since the L frame that is finally generated is the same as an original frame L₀(4), the mismatch between the encoder and the decoder due to the update step can be eliminated. However, coding performance may be somewhat lowered because the update step is never applied to the final L frame. In the case where the number of frames included in one GOP is large, the influence thereof may not be great. The improvement of performance obtained by eliminating the mismatch between the encoder and the decoder may exceed the disadvantage of the lowered performance in many cases.

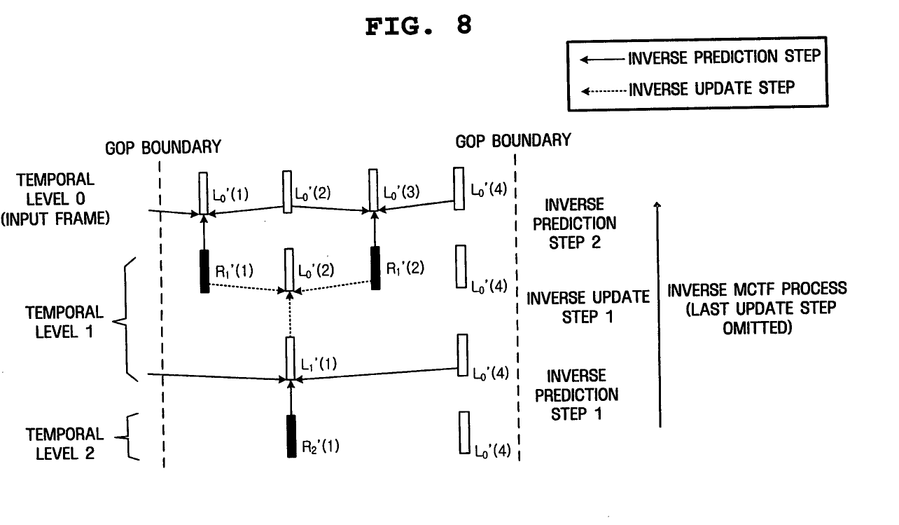

In FIG. 7, the R frames R₁(1), R₁(2) and R₂(1) and the original input frame L₀(4) at the final L frame location are transmitted to the decoder after being encoded. The decoder restores the original input frames L₀(1), L₀(2), L₀(3) and L₀(4) using the received frames through the process as shown in FIG. 8. It can be seen that the process of FIG. 8 is the same as the inverse MCTF process (refer to FIG. 5) of mode 0 except that the update step for the final L frame (L₀′(4)) is omitted.

The method of performing the update step using the lower layer (hereinafter referred to as “mode 2”) will be described below. Mode 2 is a method of performing the update step using the H frame of a lower layer instead of the H frame obtained in a current layer if there is no significant difference between the quality of the lower layer and the quality of the current layer.

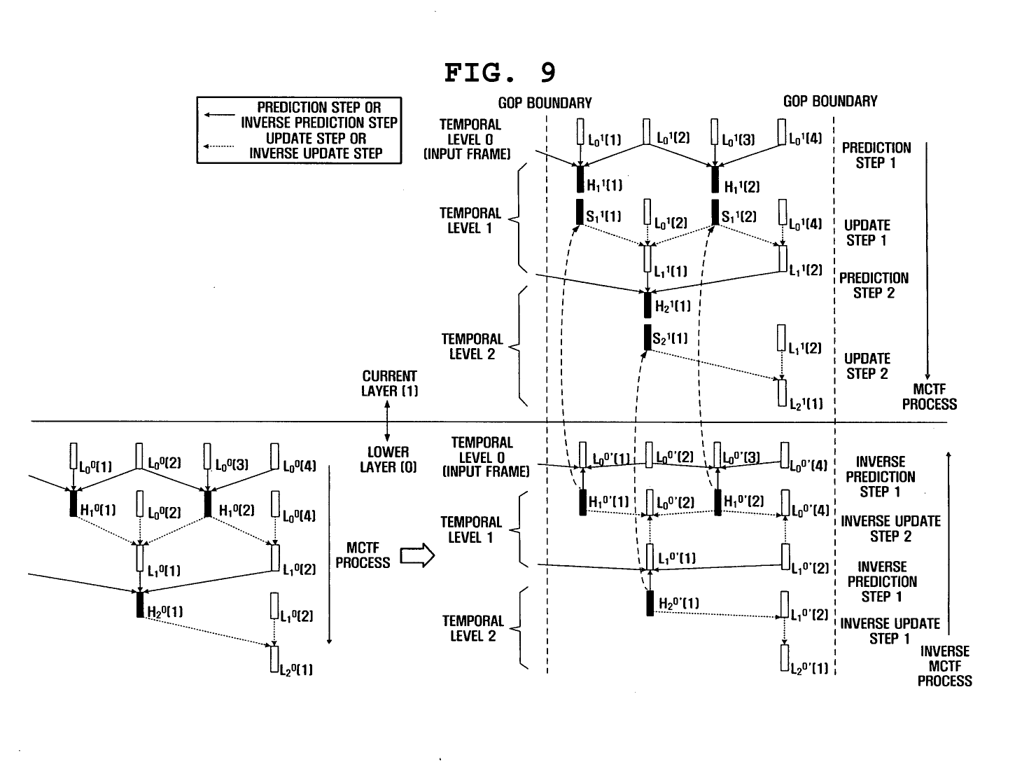

FIG. 9 is a view illustrating mode 2. All of the frames of a current layer (1) are affixed with a superscript “1” and all of the frames of a lower layer (0) are affixed with a subscript “0”. In FIG. 9, it is indicated that the frame rates of the current layer and the lower layer are the same. However, when the frame rate of the lower layer is lower than that of the current layer, mode 2 can be applied between corresponding H frames in the same way.

The core of mode 2 resides in using virtual H frames (hereinafter referred to as “S frames”), which are generated using corresponding lower layer information, and not unquantized H frames, when performing the update step. However, it should be noted that the S frames S₁¹(1), S₁¹(2) and S₂¹(1) are used only in the update step, and the H frames H₁¹(1), H₁¹(2) and H₂¹(1) are used without change in the prediction step. In the same manner, in the decoder, the S frames will be used in the inverse update step and the H frames will be used in the inverse prediction step.

In that case, information that may be used to generate the S frame includes L⁰′ (the restored L frame of a lower layer), L¹ (the L frame of a current layer that has not undergone the restoration process of the current layer), P⁰′ (a predicted frame of a lower layer that is generated from a restored L frame) and P¹ (the predicted frame of a current layer).

Since the update process based on the conventional MCTF is performed using unencoded H frames, a mismatch occurs between the encoder and the decoder. Therefore, mode 2 attempts to use lower layer information that can provide restored frames at the time of updating a current layer. It should be noted that, in mode 2, all the frames fetched from the lower layer are restored frames. In addition, if the resolution of a lower layer is different from the resolution of a current layer at the time of using the frame of the lower layer, the frame of the lower layer must be properly up-sampled.

Mode 2 may also be classified into three detailed modes. In mode 2-1, S frames are obtained from L⁰′-P⁰′. For example, in FIG. 9, an S frame S₁¹(2) used to update L₀¹(4) is obtained by subtracting the predicted frame P⁰′ of a lower layer, which is calculated from L₀⁰′(2) and L₀⁰′(4), from L₀⁰′(3). This is the same as H₁⁰′(2), that is, a result obtained by restoring the H frame of the lower layer.

Mode 2-1 is advantageous in that a mismatch does not occur between the encoder and the decoder because already restored frames are used, and additional calculation is not required because the S frame itself is a result obtained by restoring the H frame of the lower layer.

In mode 2-2, S frames are obtained from L¹-P⁰′. For example, in FIG. 9, the S frame S₁¹(2) used to update L⁰¹(4) is obtained by subtracting the predicted frame P⁰′, which is calculated from the restored frames L⁰⁰′(2) and L⁰⁰′(4) of a current layer, from the frame L₀¹(3) of a lower layer. According to mode 2-2, a mismatch is somewhat reduced compared to existing MCTF, but a predicted frame P⁰′ is generated using the motion vector of the lower layer, not a value based on the motion vector of a current layer. Therefore, there is a case where efficiency is somewhat lowered.

In mode 2-3, S frames are obtained from L⁰′-P¹. For example, the S frame(S₁¹(2)) used to update L₀¹(4) in FIG. 9 is obtained by subtracting the predicted frame (P¹), which is calculated from L₀¹(2) and L₀¹(4) of a current layer, from the restored frame L₀⁰′(3) of a lower layer.

P¹ is generated using the motion vector of a current layer. The mismatch is reduced and the amount of calculation is small compared to existing MCTF. However, since a restored lower layer frame L⁰′ is used instead of a current layer frame L¹, the improvement of performance further increases when the lower layer frame is significantly similar to the current layer frame.

The difference between the S frame based on mode 2-3 and the H frame used in the inverse update step on the decoder will be described below. The H frame in the decoder can be expressed by the following Equation 7 and the S frame based on mode 2-3 can be expressed by the following Equation 8.
H=L¹−P¹′=(L¹−P¹)+(P¹−P¹′) (7)
S=L⁰′−P¹=(L¹−P¹)+(L⁰,−L¹) (8)

From the comparison between Equations 7 and 8, it can be appreciated that the former terms of the Equations are the same and the latter terms of both Equations respectively correspond to the differences between restored values (P¹′ and L⁰′ are restored values) and original values and the values thereof are relatively low, so that the mismatch between the inter encoder and the decoder can be effectively reduced when mode 2-3 is followed.

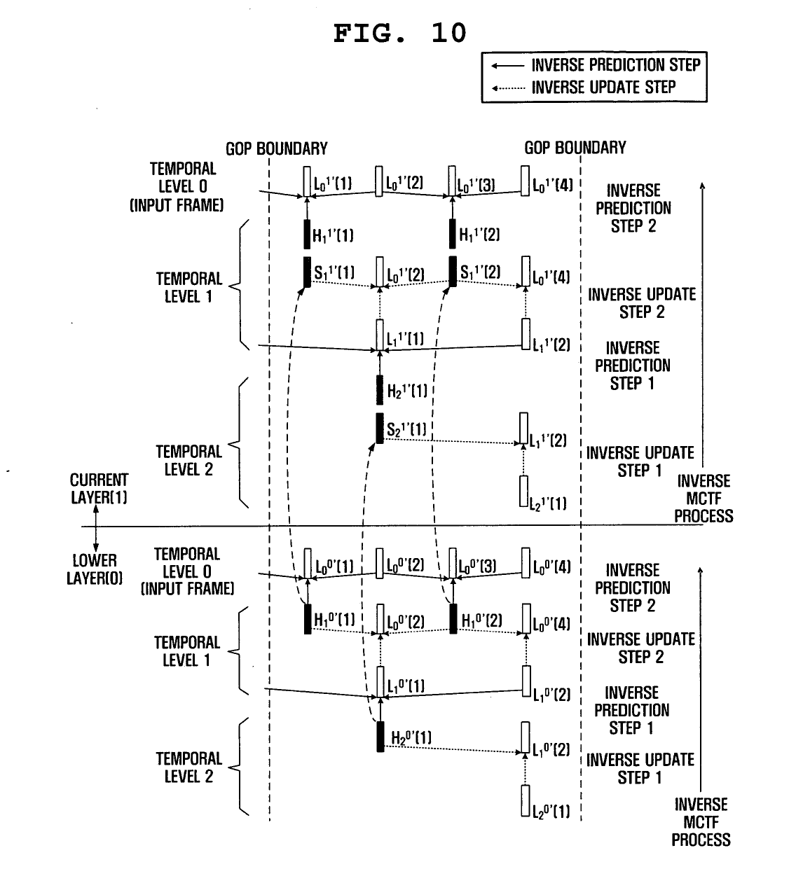

The decoding process according to mode 2 will be described with reference to FIG. 10. The frames of a lower layer (0) are restored through an existing inverse MCTF process. The frames of a current layer (1) are also restored by repeating an inverse update step and an inverse prediction step. The S frame(s) is used at the inverse update step and the H frame(s) is used at the inverse prediction step. The H frame used at the inverse prediction step is the result of performing inverse quantization and inverse transform on the H frame transferred from an encoder. The S frame used in the inverse update step is not a value transferred from an encoder, but is a virtual H frame that is estimated from the restored frame of a lower layer and the restored frame of a current layer. The method of generating the S frame may vary depending on mode 2-1, 2-2 or 2-3, as described above. The decoder can generate the S frame based on a predetermined mode 2-1, 2-2 or 2-3, or it can generate the S frame based on selected mode information transferred from the encoder.

Mode 2 is the same as the existing MCTF process except that the H frame used at the update process is changed to a value that can reduce the mismatch between the encoder and the decoder. However, since mode 2 employs lower layer information, it has a limitation in that it can be used only in a video codec having multiple layers.

A method in which mode 0 and mode 2 are mixed and then used may be considered. That is, for the prediction step, the re-estimated H frame, that is, the frame R, is used as in mode 0, and for the update step, the S frame is used as in mode 2. In a similar way, in the decoder stage, the S frame is used at the inverse update step and the frame R is used at the inverse prediction step.

Thereafter, mode 3 is a method using the weighted mean of the H frame based on the existing MCTF method and the S frame based on mode 2. According to mode 3, a result S″, which is the weight-mean of the H frame based on the existing MCTF method and the S frame based on mode 2, is used to update the L frame, as in Equation 9:
S″=(1−α)H+αS; (9)

where α is a constant having a value between 0 and 1. According to mode 3, an improvement in performance can be obtained by mixing the existing MCTF method, which is capable of minimizing residual energy, and the method of mode 2, which is capable of reducing the mismatch between the encoder and the decoder.

Adaptive Selection of Update Step Process

The methods proposed in mode 0 to mode 3 are very effective when the existing MCTF method is not effective, that is, when the mismatch between the encoder and the decoder is problematic. When motion is constant or very small, there is a case where the existing open-loop-based MCTF exhibits superior performance. Therefore, the existing MCTF method and the methods (mode 0 to mode 3) proposed in the present invention can be selectively used. The selection may be performed on a frame, slice (defined in H.264) or macroblock basis. The criterion for selection may be the selection of a method in which the number of bits of data (including motion data and texture data), which are generated as a result of performing coding according to a plurality of methods serving as the targets of comparison, is small, or the selection of a method in which a rate-distortion (R-D)-based cost function is minimal.

In the present invention, in order to notify the decoder of the selected result, a new flag called “CLUFlag” is introduced, and a selected mode number (one of 0 to 3) according to the present invention can be recorded as the value of the flag (mode 2 can also be classified into sub-divided modes), or a number (for example, “4”) according to the existing MCTF method can be recorded as the value of the flag. When CLUFlag is 0, it indicates coding according to the existing MCTF. When CLUFlag is 1, it indicates coding based on one of the modes according to the present invention (modes that have been previously agreed upon by the encoder and the decoder).

In the case where the basis is a frame basis, CLUFlag can be recorded in a frame header. In the case where the basis is a slice basis, CLUFlag can be recorded in a slice header. Furthermore, in the case where the basis is a macroblock basis, CLUFlag can be recoded and included in macroblock syntax.

Alternately, a method in which the above methods are blended with each other can be used. In this method, if the value of CLUFlag in the slice header is 0, it implies that the existing MCTF method is applied to the entire frame. If the value of CLUFlag in the slice header is 1, it indicates that one of the modes according to the present invention (modes that are previously agreed between the encoder and the decoder) is applied to the entire frame. If the value of CLUFlag in the slice header is 2, it indicates that the existing MCTF method and the mode according to the present invention are mixed and applied on a macroblock basis.

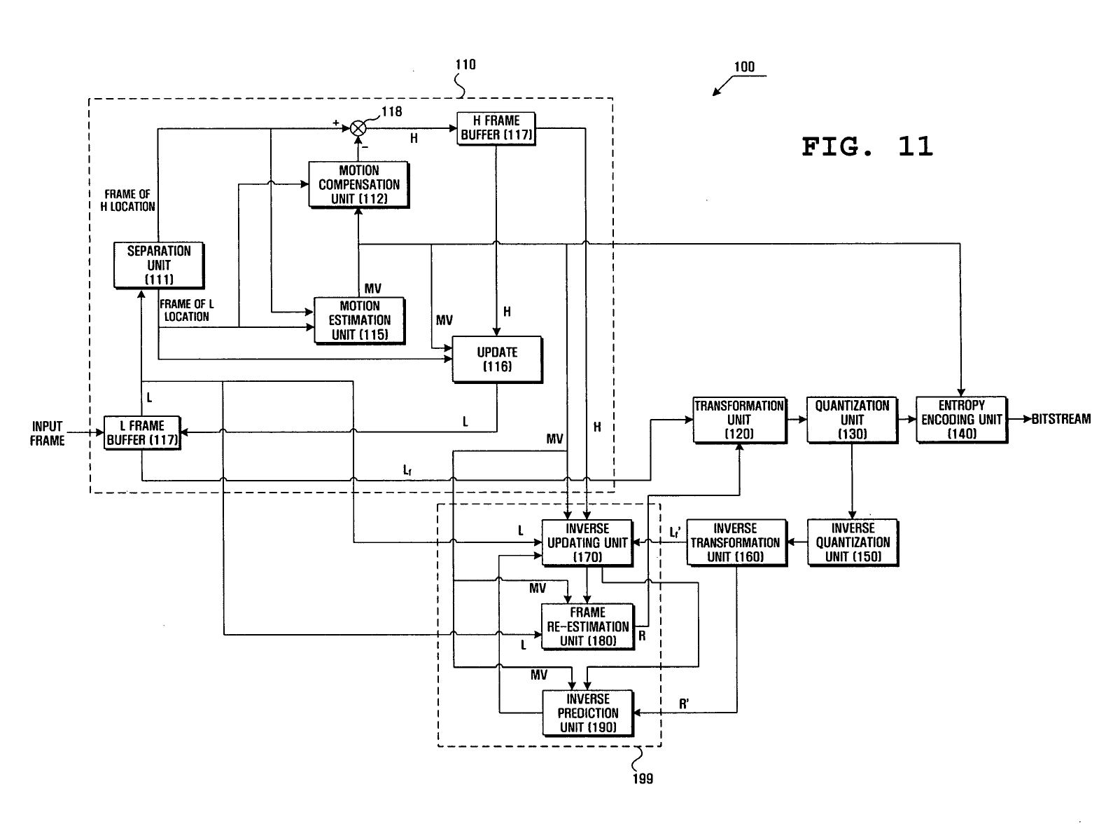

FIG. 11 is a block diagram of the video encoder 100 based on mode 0 according to an exemplary embodiment of the present invention.

Frames are input to an L frame buffer 117. This is because the input frames can belong to L frames (low-frequency frames). The L frames stored in the L frame buffer 117 are provided to a separation unit 111.

The separation unit 111 separates the received low-frequency frames into frames at high-frequency frame locations (H locations) and frames at low-frequency frame locations (L locations). In general, the high-frequency frames are located at odd-numbered locations (2i+1) and the low-frequency frames are located at even-numbered locations (2i). In this case, “i” is an index indicating a frame number. The H location frames are transformed into H frames through the prediction step. The L location frames are transformed into low-frequency frames in a next temporal level through the update step.

The H location frames are input to a motion estimation unit 115 and a subtractor 118.

The motion estimation unit 115 obtains a motion vector (MV) by performing motion estimation on the frames at the H location (hereinafter referred to as a “current frame”) with reference to neighboring frames (frames in the same temporal level located at temporally different locations). The neighboring frames to which reference is made as described above are referred to as “reference frames”.

In general, for such motion estimation, a block-matching algorithm is widely used. In this algorithm, a displacement when error is the lowest, while a predetermined block moves within a specific search region of the reference frame on a pixel or sub-pixel (e.g., ¼ pixel) basis, is estimated as an MV. For motion estimation, a fixed block can be employed, but a hierarchical method using Hierarchical Variable Size Block Matching (HVSBM) may be employed.

The MV obtained in the motion estimation unit 115 is provided to a motion compensation unit 112. The motion compensation unit 112 generates a predicted frame for the current frame by performing motion compensation on the reference frame using the obtained MV. The predicted frame can be expressed as P(Lₜ(2k−1)) of Equation 1.

Furthermore, the subtractor 118 generates a high-frequency frame (an H frame) by subtracting the predicted frame from the current frame. The generated high-frequency frame is buffered in the H frame buffer 117.

The updating unit 116 generates low-frequency frames by updating the L location frames using the generated high-frequency frame. In the case of 5/3 MCTF, a frame at a predetermined L location can be updated using two high-frequency frames that are temporally adjacent to each other. If unidirectional reference is used in a process of generating the high-frequency frames (for example, when Haar MCTF is used), the update process can also be performed unidirectionally in the same manner. The update process can be expressed in the second term of Equation 1. The low-frequency frames generated in the updating unit 116 are buffered in the L frame buffer 117. The L frame buffer 117 provides the generated low-frequency frames to the separation unit 111 in order to perform a prediction step and an update step in a next temporal level.

However, in the case where the generated low-frequency frames is a single final low-frequency frame L_{f}, the final low-frequency frame L_{f} is provided to a transformation unit 120 because a next temporal level does not exit.

The transformation unit 120 performs a spatial transform process on the received final low-frequency frame L_{f} and generates a transform coefficient. This spatial transform method can include a Discrete Cosine Transform (DCT) method, a wavelet transform method or the like. In the case where the DCT method is used, the transform coefficient becomes a DCT coefficient. In the case where the wavelet transform method is used, the transform coefficient becomes a wavelet coefficient.

A quantization unit 130 quantizes the transform coefficient. The quantization process is a process of representing the transform coefficient, which is represented by a predetermined real value, by discrete values. For example, the quantization unit 130 can perform a quantization process of dividing the transform coefficient, which is represented by a predetermined real value, using a predetermined quantization step and rounding off the result to an integer value (in the case where scalar quantization is used). The quantization step can be provided from a previously agreed quantization table.

The quantization result obtained by the quantization unit 130, that is, the quantization coefficient with respect to L_{f}, is provided to an entropy encoding unit 140 and an inverse quantization unit 150.

The inverse quantization unit 150 inversely quantizes the quantization coefficient with respect to L_{f}. The inverse quantization process is a process of restoring a value matching an index, which is generated in the quantization process, from the index using the same quantization table as that used in the quantization process.

An inverse transformation unit 160 receives an inverse quantization result and performs an inverse transform process on the received inverse quantization result. The inverse transform process is performed in an inverse manner to the transform process of the transformation unit 120. In more detail, an inverse DCT transform method, an inverse wavelet transform method and so on can be used for the inverse transform process. The inverse transform result, that is, the restored final low-frequency frame f (referred to as Lf′), is provided to the inverse updating unit 170.

A re-estimation module 199 re-estimates the high-frequency frame using the restored final low-frequency frame Lf′. An example of the re-estimation process is shown in FIG. 4. For this purpose, the re-estimation module 199 includes an inverse updating unit 170, a frame re-estimation unit 180, and an inverse prediction unit 190.

The inverse updating unit 170 performs an inverse update process on Lf′ using a high-frequency frame that is from the high-frequency frames that are resolved in the MCTF process and then buffered in the H frame buffer 177, and that is of the same temporal level as Lf′. The inverse update process may be performed according to Equation 4. In this process, an MV of the high-frequency frame, which is obtained in the motion estimation unit 115, is employed. Taking FIG. 4 as an example, the inverse updating unit 170 updates L₂′(1) using H₂(1) and, as a result, generates L₁′(2).

The frame re-estimation unit 180 generates a predicted frame using the inversely updated frame, and re-estimates the high-frequency frame by obtaining a difference between the low-frequency frame (that is, the original low-frequency frame of the high-frequency frame) in a temporal level, which is lower than that of the high-frequency frame by one level, and the predicted frame. As a result, a re-estimated frame (R) is generated. The high-frequency frame re-estimation process may be performed according to Equation 5.

Taking FIG. 4 as an example, the frame re-estimation unit 180 generates a predicted frame using L₁′(2) (and the restored low-frequency frame of a previous GOP). To generate the predicted frame, an MV is needed. The MV of a high-frequency frame (H₂(1)) may be used without change, and an MV may be obtained by performing an additional motion estimation process. The frame re-estimation unit 180 finds a difference between an original low-frequency frame L₁(1) of the high-frequency frame H₂(1) and the predicted frame.

The re-estimated frame R is restored through the transformation unit 120, the quantization unit 130, the inverse quantization unit 150 and the inverse transformation unit 160. The restored re-estimated frame R′ is input to the inverse prediction unit 190.

The inverse prediction unit 190 inversely predicts L₁′(1) using the restored re-estimated frame R₂′(1) and the updated low-frequency frame L₁′(2). The inverse prediction process can be performed according to Equation 6. The inversely predicted L₁′(1) is a value that is equal to that at the decoder. Thereafter, after the inverse update step has been performed through the inverse updating unit 170, R₁(1) and R₁(2) are generated by re-estimating the remaining high-frequency frames H₁(1) and H₁(2) through the frame re-estimation unit 180. Therefore, since three high-frequency frames exist in the example of FIG. 4, re-estimated frames for the three high-frequency frames are all found. If other high-frequency frames exist, R₁(1) and R₁(2) can also be used to re-estimate other high-frequency frames after undergoing the coding/decoding process.

The re-estimated frames R include re-estimated frames for all of the high-frequency frames, and undergo the transform process of the transformation unit 120 and the quantization process of the quantization unit 130. The re-estimated frames that have undergone the above processes need not undergo the same process as in R₂(1) of FIG. 4.

The entropy encoding unit 140 receives the quantization coefficient of the final low-frequency frame L_{f}, which is generated by the quantization unit 130, and the quantization coefficient of the re-estimated high-frequency frames R, and generates a bitstream by performing lossless encoding on the coefficients. The lossless encoding method may include Huffman coding, arithmetic coding, variable length coding and a variety of other methods.

The block diagram based on mode 1 has the same construction as that of FIG. 11 except that, in the case where the low-frequency frame is located at the location of the final low-frequency frame when the updating unit 116 of FIG. 11 performs the update step, the update step on the low-frequency frame is omitted.

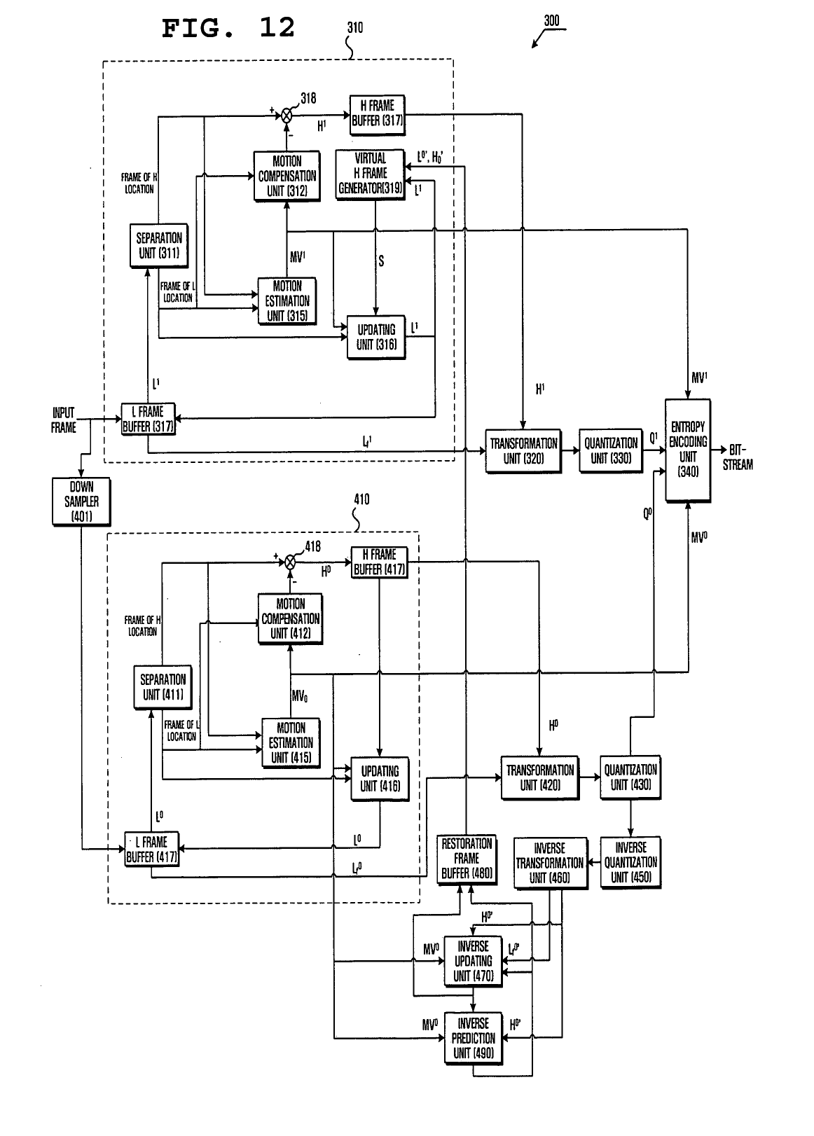

FIG. 12 is a block diagram illustrating the construction of the video encoder 300 based on mode 2 according to an exemplary embodiment of the present invention. Mode 2 is applied to a multi-layered frame. A video encoder 300 includes a lower layer encoder and a current layer encoder, as shown in FIG. 12. In FIG. 12, a superscript 0 or 1 is an index that identifies a layer, and superscript 0 indicates a lower layer and superscript 1 indicates a current layer.

Frames are input to an L frame buffer 317 and the down sampler 401 of the current layer. The down sampler 401 performs down sampling spatially or temporally. The spatial down sampling process is performed to reduce resolution and the temporal down sampling process is performed to reduce frame rate. The down-sampled frames are input to an L frame buffer 417 of the lower layer. An MCTF module 410 of the lower layer performs the prediction and update steps of a general MCTF process. Descriptions thereof will be omitted to avoid redundancy.

At least one high-frequency frame H⁰ and a final low-frequency frame L_{f}⁰ generated in the MCTF module 410 are restored through a transformation unit 420, a quantization unit 430, an inverse quantization unit 450 and an inverse transformation unit 460. The restored high-frequency frame H⁰′ is provided to an inverse prediction unit 490 and the restored low-frequency frame L_{f}⁰′ is provided to an inverse updating unit 470.

The inverse updating unit 470 and the inverse prediction unit 490 restore the low-frequency frames L⁰′ in each temporal level while repeatedly performing the inverse update and inverse prediction steps. The inverse update and inverse prediction steps are general steps in the inverse MCTF process.

A restoration frame buffer 480 buffers the restored low-frequency frames L⁰′ and the restored high-frequency frame H⁰′ and provides them to a virtual H frame generator 319.

The low-frequency frame L¹ in an L frame buffer 317 is separated into H and L location frames using the separation unit 311. The prediction step that is performed in the MCTF module 310 of the current layer is the same as the MCTF process performed in the MCTF module 410 of the lower layer. However, the prediction step is different from the MCTF process in that the update step is not performed using the high-frequency frame H¹ as in the MCTF module 310 of the lower layer, but is performed using the virtual high-frequency frame S estimated from information of the lower layer.

As described above, the virtual H frame generator 319 generates a virtual high-frequency frame S using the restored frames L⁰′ and H⁰′ of the lower layer and provides the generated virtual high-frequency frame S to an updating unit 316.

The method of generating the virtual H frame may include three modes (mode 2-1, mode 2-2 and mode 2-3) as described above.

According to mode 1, the decoded high-frequency frame H⁰′ is used as the virtual high-frequency frame S without change. In this case, as shown in FIG. 9, the high-frequency frames H₁¹(1), H₁¹(2) and H₂¹(1) of the lower layer are replaced with the virtual high-frequency frames S₁¹(1), S₁¹(2) and S₂¹(1) without change.

According to mode 2, the virtual H frame generator 319 generates a predicted frame from the restored low-frequency frames L⁰′ of the lower layer, and subtracts the predicted frame from the low-frequency frame L¹ of the current layer, which is provided from the L frame buffer 317, thus generating the virtual high-frequency frame S. When the predicted frame is generated, an MV generated in a motion estimation unit 415 of the lower layer can be employed.

According to mode 3, the virtual H frame generator 319 generates the virtual high-frequency frame S by subtracting the predicted frame, which is used to generate the H frame of the current layer, from the one of the restored low-frequency frames L⁰′ of the lower layer frame that corresponds to a current frame. The current frame refers to L₀¹(1) when S₁¹(1) is desired to be generated, L₀¹(3) when S₁¹(2) is desired to be generated, and L₁¹(1) when S₁¹(1) is desired to be generated, in FIG. 9.

The updating unit 316 inversely updates a low-frequency frame at a predetermined temporal level using the generated S frame, and generates a low-frequency frame at a temporal level that is one higher than the temporal level.

Information, which is encoded in the current layer and then transmitted to the decoder, includes the final low-frequency frame L_{f}¹ and the high-frequency frame H¹, but does not include the frame S. This is because the frame S can be estimated/generated in the decoder in the same manner as in the encoder.

An entropy encoding unit 340 generates a bit stream by losslessly encoding a quantization coefficient Q¹ with respect to L_{f}¹ and H¹, which are generated in the quantization unit 330, the MV MV¹ of the current layer, a quantization coefficient Q⁰ with respect to L_{f}⁰ and H⁰, which are generated in the quantization unit 430, and the MV MV⁰ of the lower layer.

According to mode 3, the virtual high-frequency frame S is not directly used in the update step, but the weight mean of the high-frequency frame H and the virtual high-frequency frame S is applied to the update step. Therefore, according to mode 3, a process in which the virtual H frame generator 319 calculates the weighted mean, as in Equation 9, can be further added.

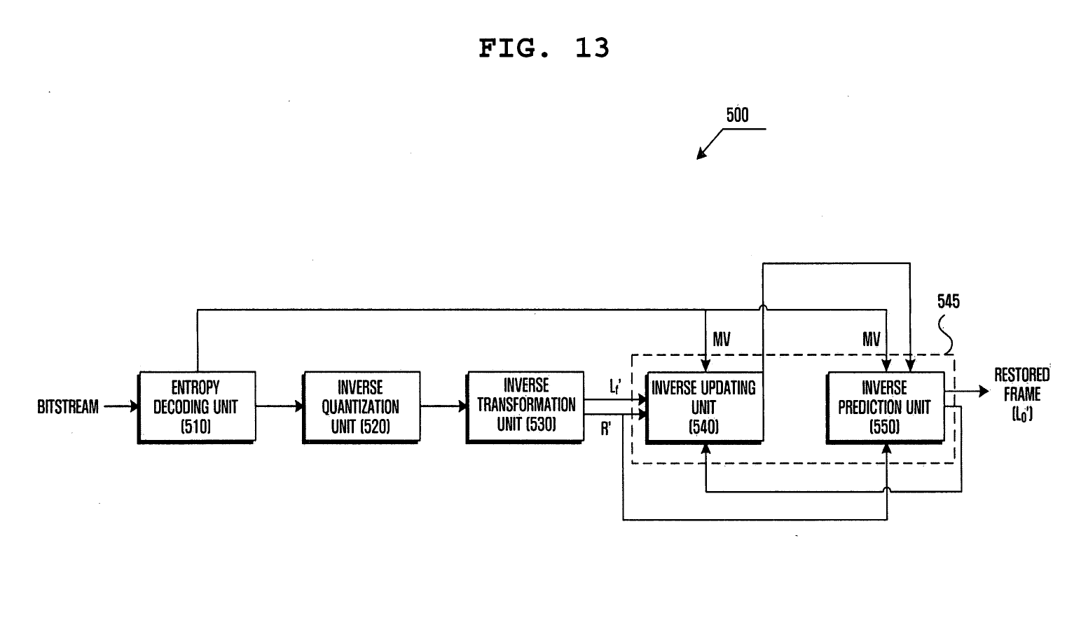

FIG. 13 is a block diagram of the construction of the video decoder 500 based on mode 0 according to an exemplary embodiment of the present invention.

An entropy decoding unit 510 performs a lossless decoding process and, thereby, extracts texture data and MV data with respect to each frame from a received bitstream. The extracted texture data is provided to an inverse quantization unit 520 and the extracted MV data is provided to an inverse updating unit 540 and an inverse prediction unit 550.

The inverse quantization unit 520 performs inverse quantization on the texture data output from the entropy decoding unit 510. The inverse quantization process is a process of restoring a value matching an index, which is generated in the quantization process, from the index using the same quantization table that is used in the quantization process.

The inverse transformation unit 530 performs an inverse transform on the inverse quantization result. The inverse transform process is performed by a method corresponding to the transformation unit 120 of the video encoder 100. In more detail, an inverse DCT transform method, an inverse wavelet transform method or the like can be used. As a result of the inverse transform process, a final low-frequency frame and a re-estimated high-frequency frame are restored.

The restored final low-frequency frame L_{f}′ is provided to the inverse updating unit 540. The restored re-estimated high-frequency frame R′ is provided to the inverse updating unit 540 and the inverse prediction unit 550. An inverse MCTF module 545 generates a frame L₀′ that is finally restored by repeatedly performing an inverse update step on the inverse updating unit 540 and an inverse prediction step on the inverse prediction unit 550. The inverse update step and the inverse prediction step are repeated until a frame at a temporal level 0, that is, the received frame at the encoder 100, is restored.

The inverse updating unit 540 performs inverse update on L_{f}′ using the frame of R′ at a temporal level identical to that of Lf′. At this time, an MV that the frame of the same temporal level is used. Furthermore, the inverse updating unit 540 repeatedly performs the inverse update process using the low-frequency frame received from the inverse prediction unit 550 in the same manner.

The inverse prediction unit 550 restores the current low-frequency frame by performing inverse prediction on the re-estimated high-frequency frame R′ using the low-frequency frame (a peripheral low-frequency frame) that is inversely updated in the inverse updating unit 540. To this end, the inverse prediction unit 550 generates a predicted frame for a current low-frequency frame by performing motion compensation on the peripheral low-frequency frame using an MV received from the entropy decoding unit 510, and adds the re-estimated high-frequency frame R′ and the predicted frame. The inverse prediction step can be performed in a manner reverse to the prediction step, as in Equation 6. The current low-frequency frame generated by the inverse prediction unit 550 can also be provided to the inverse updating unit 540. The inverse prediction unit 550 outputs the restored frame L₀′ in the case where an input frame of a temporal level 0 is restored as a result of inverse prediction.

The block diagram according to mode 1 has the same construction as FIG. 13, and there is a difference in that the update step for the low-frequency frame is omitted in the case where a low-frequency frame is positioned at the location of a final low-frequency frame when the inverse updating unit 540 performs the inverse update step on a predetermined low-frequency frame.

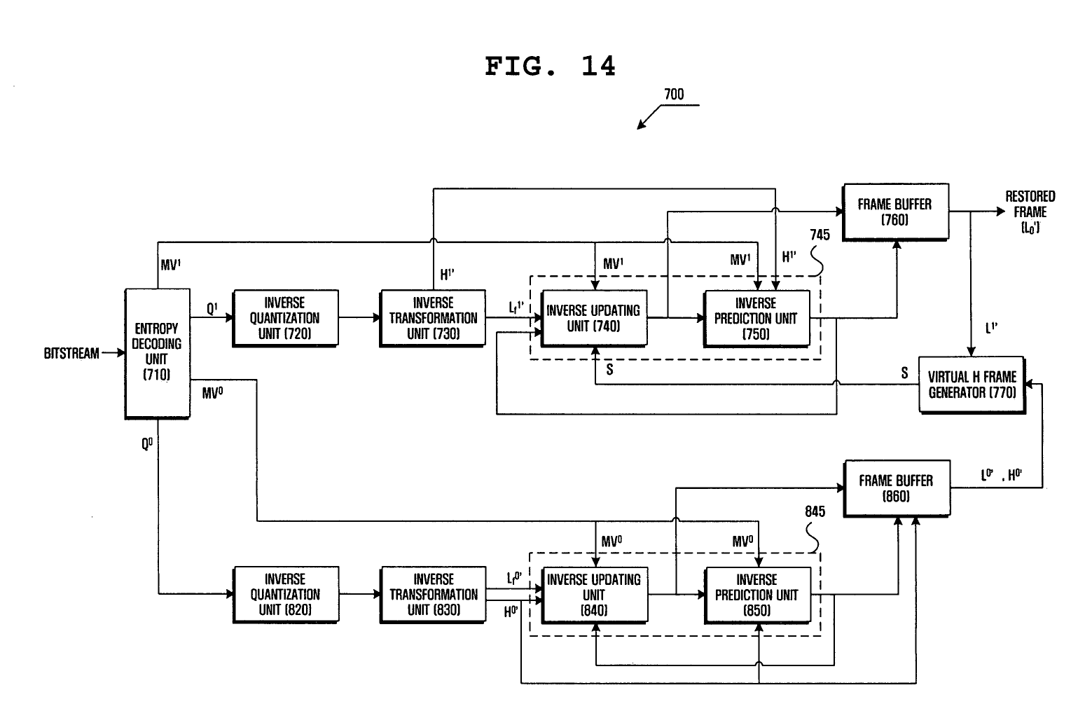

FIG. 14 is a block diagram illustrating the construction of a video decoder 700 based on mode 2 according to an exemplary embodiment of the present invention. Since mode 2 is applied to multi-layer frames, the video decoder 700 includes a lower layer encoder and a current layer encoder, as shown in FIG. 14. In FIG. 14, a superscript 0 or 1 is an index that distinguishes layers, and 0 indicates the lower layer and 1 indicates the current layer.

An entropy decoding unit 710 performs lossless decoding, and extracts from an input bitstream texture data and MV data with respect to each frame. The texture data includes the texture data Q¹ of a current layer and the texture data Q⁰ of a lower layer. The MV data includes the MV MV¹ of the current layer and the MV Q⁰ of the lower layer.

The operation of the lower layer will be first described. An inverse quantization unit 820 performs an inverse quantization on Q₀. An inverse transformation unit 830 performs an inverse transform on the inversely quantized result. As a result, a final low-frequency frame L_{f}⁰′ and at least one or more high-frequency frames H⁰′ of the lower layer are restored.

The restored final low-frequency frame L_{f}′ is provided to an inverse updating unit 840. The restored high-frequency frame H⁰′ is provided to the inverse updating unit 840 and an inverse prediction unit 850. An inverse MCTF module 845 generates a restored frame L₀′ by repeatedly performing the inverse update step on the inverse updating unit 840 and the inverse prediction step on the inverse prediction unit 850. The inverse update step and the inverse prediction step are repeated until the frame of a temporal level 0, that is, the input frame at the encoder 100, is restored.

The inverse updating unit 840 performs an inverse update process on L_{f}⁰′ using a frame among H⁰′ that has the same temporal level as that of L_{f}⁰′. At this time, an MV of the frame of the same temporal level is used. Furthermore, the inverse updating unit 840 repeatedly performs the inverse update process using a low-frequency frame received from the inverse prediction unit 850 in the same manner.

The inverse prediction unit 850 restores a current low-frequency frame by performing an inverse prediction process on the high-frequency frame H⁰′ using the low-frequency frame (a peripheral low-frequency frame) that is inversely updated in the inverse updating unit 840. To this end, the inverse prediction unit 850 generates a predicted frame for the current low-frequency frame by performing motion compensation on the peripheral low-frequency frame using the MV MV⁰ received from the entropy decoding unit 710, and adds the high-frequency frame H⁰′ and the predicted frame. The current low-frequency frame generated by the inverse prediction unit 850 can be provided to the inverse updating unit 840.

The low-frequency frame generated as a result of the inverse update process and the low-frequency frame generated as a result of the inverse prediction process are stored in a frame buffer 860 and then provided to a virtual H frame generator 770.

The operation of the current layer is the same as that of the lower layer except that in mode 2, the restored high-frequency frame H¹′ is used in the inverse prediction step, whereas the virtual high-frequency frame (the frame S) is used instead of the high-frequency frame H¹′ in the inverse update step.

The virtual H frame generator 770 receives restored frames of the lower layer L⁰′ and H⁰′ from the frame buffer 860 and a restored low-frequency frame (L¹′) of the upper layer from the frame buffer 760, generates a virtual high-frequency frame S, and provides the frame S to the inverse updating unit 740. The method of generating a virtual H frame may include three modes (mode 2-1, mode 2-2 and mode 2-3) as described above with reference to FIG. 12. The method is also the same as that of FIG. 12. A description thereof will be omitted in order to avoid redundancy.

Of the low-frequency frames L¹′ stored in the frame buffer 760, the frames of a temporal level 0, that is, the restored input frame L₀′, are output.

According to mode 3, the virtual high-frequency frame S is not directly used in the update step, but a weighted mean of the high-frequency frame H and the virtual high-frequency frame S is applied to the update step. Therefore, according to mode 3, a process of allowing the virtual H frame generator 770 to calculate the weighted mean will be further added, as in Equation 9.

FIG. 15 shows the construction of a system for performing the operation of the video encoders 100 and 300 or the video decoders 500 and 700 according to an exemplary embodiment of the present invention. The system may be a set-top box, a desk top computer, a laptop computer, a palmtop computer, a Personal Digital Assistant (PDA), a video or image storage device (for example, a Video Cassette Recorder (VCR) and a Digital Video Recorder (DVR)) or the like. The system may be a combination of the above-described devices, or one of the above-described devices may be included in another device. The system may include at least one video source 910, at least one Input/Output (I/O) device 920, a processor 940, memory 950 and a display device 930.

The video source 910 may be a TV receiver, a VCR or some other video storage device. Furthermore, the video source 910 may be at least one network connection for receiving video from a server via the Internet, a Wide Area Network (WAN), a Local Area Network (LAN), a terrestrial broadcasting system, a cable network, a satellite communication network, a wireless network, a telephone network or the like. In addition, the video source can be a combination of the above-described networks, or one of the above-described networks may be included in another network.

The I/O device 920, the processor 940 and the memory 950 communicate with each other via a communication medium 960. The communication medium 960 may be a communication bus, a communication network, or at least one internal connection circuit. Input video data received from the video source 910 may be processed by the processor 940 according to one or more software programs stored in the memory 950, and may be executed by the processor 940 so as to generate output video that is provided to the display apparatus 930.

In particular, the software programs stored in the memory 950 may include a scalable video codec that performs the method according to the present invention. The encoder or the codec may be stored in the memory 950, may be read from a storage medium such as a CD-ROM or a floppy disk, or may be downloaded from a predetermined server via one of various networks. The codec may be software, a hardware circuit, or a combination of software and a hardware circuit.

As described above, in the MCTF-based video encoding/decoding method according to the present invention, the mismatch between an encoder and a decoder, which exists in the existing method, is reduced, while the advantages of the existing prediction and update steps are maintained. Therefore, compression efficiency can be improved in comparison with existing MCTF. More particularly, when residual energy is high, the present invention exhibits better performance because the motion is fast.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A video encoding method comprising:
dividing input frames into one final low-frequency frame and at least one high-frequency frame by performing motion compensated temporal filtering on the input frames;
encoding the final low-frequency frame and decoding the encoded final low-frequency frame;
re-estimating the at least one high-frequency frame using the decoded final low-frequency frame; and
encoding the re-estimated high-frequency frame.

2. The video encoding method as set forth in claim 1, further comprising generating a bitstream from the encoded final low-frequency frame and the encoded high-frequency frame.

3. The video encoding method as set forth in claim 1, wherein the dividing the input frames comprises:
generating a predicted frame for a current frame with reference to frames of the input frames, which are located at different temporal locations, and obtaining the at least one high-frequency frame by subtracting the predicted frame from the current frame; and
updating the frames at different temporal locations using the at least one high-frequency frame.

4. The video encoding method as set forth in claim 1, wherein the encoding the final low-frequency frame and the decoding the encoded final low-frequency frame comprises:
generating transform coefficients by transforming the low-frequency frame;
quantizing the transform coefficients;
inversely quantizing a result of the quantizing; and
inversely transforming a result of the inverse quantizing.

5. The video encoding method as set forth in claim 1, wherein the re-estimating the at least one high-frequency frame comprises:
inversely updating the decoded final low-frequency frame using first high-frequency frames of a temporal level identical to that of the final low-frequency frame; and
re-estimating the first high-frequency frame by subtracting a predicted frame, which is generated using the inversely updated final low-frequency frame, from a low-frequency frame of a temporal level, which is lower than that of the first high-frequency frames by one level.

6. The video encoding method as set forth in claim 5, wherein the re-estimating the at least one high-frequency frame comprises:
encoding the re-estimated first high-frequency frames and then decoding the encoded first high-frequency frames; and
re-estimating remaining high-frequency frames using the decoded first high-frequency frames.

7. The video encoding method as set forth in claim 1, wherein the dividing the input frames comprises:
generating a predicted frame for a current frame with reference to frames located at different temporal locations, and obtaining the at least one high-frequency frame by subtracting the predicted frame from the current frame; and
updating the frames at different temporal locations using the obtained high-frequency frames if the frames located at different temporal locations are not located at the location of the final low-frequency frame.

8. The video encoding method as set forth in claim 7, wherein the re-estimating the at least one high-frequency frame comprises:
re-estimating the at least one first high-frequency frame by subtracting the predicted frame generated using the decoded final low-frequency frame;
encoding the re-estimated first high-frequency frame and decoding the encoded first high-frequency frame; and
re-estimating remaining high-frequency frames using the decoded first high-frequency frame.

9. A video encoding method comprising:
dividing input frames into one final low-frequency frame and at least one high-frequency frame by performing motion compensated temporal filtering on the input frames; and
encoding the final low-frequency frame and the at least one high-frequency frame;
wherein the dividing the input frames comprises:
generating the at least one high-frequency frame from a low-frequency frame of a current layer;
generating a virtual high-frequency frame using a restored frame of a lower layer; and
updating the low-frequency frame using the virtual high-frequency frame.

10. The video encoding method as set forth in claim 9, wherein the encoding the final low-frequency frame and the at least one high-frequency frame comprises:
generating a transform coefficient by transforming the final low-frequency frame and the at least one high-frequency frame;
quantizing the transform coefficient; and
encoding the quantized result without loss.

11. The video encoding method as set forth in claim 9, wherein the generating the at least one high-frequency frame comprises:
generating a predicted frame for a current frame with reference to low-frequency frames located at different temporal locations; and
generating the at least one high-frequency frame by subtracting the predicted frame from the current frame.

12. The video encoding method as set forth in claim 9, wherein the generating the virtual high-frequency frame comprises:
performing motion compensated temporal filtering on the frames of the lower layer; and
encoding high-frequency frames generated as a result of the motion compensated temporal filtering and decoding the encoded high-frequency frames,
wherein the virtual high-frequency frame is the decoded high-frequency frames.

13. The video encoding method as set forth in claim 9, wherein the generating the virtual high-frequency frame comprises:
performing motion compensated temporal filtering on frames of the lower layer;
encoding high-frequency frames and low-frequency frames, which are generated by the motion compensated temporal filtering, and decoding the encoded high-frequency frames and the encoded low-frequency frames;
restoring low-frequency frames of the lower layer by performing inverse motion compensated temporal filtering on the decoded high-frequency frames and the decoded low-frequency frames;
generating a predicted frame from the restored low-frequency frames of the lower layer; and
generating a virtual high-frequency frame by subtracting a predicted frame from the low-frequency frames of the current layer.

14. The video encoding method as set forth in claim 13, wherein the predicted frame is generated using a motion vector that is used when the motion compensated temporal filtering is performed on the frames of the lower layer.

15. The video encoding method as set forth in claim 11, wherein the generating the virtual high-frequency frame comprises:
performing motion compensated temporal filtering on frames of the lower layer;
encoding high-frequency frames and low-frequency frames, which are generated by the motion compensated temporal filtering, and decoding the encoded high-frequency frames and the encoded low-frequency frames;
restoring low-frequency frames of a lower layer by performing inverse motion compensated temporal filtering on the decoded high-frequency frames and the decoded low-frequency frames; and
generating a virtual high-frequency frame by subtracting the predicted frame from a frame corresponding to the current frame of the restored low-frequency frames of the lower layer.

16. A video encoding method comprising:
dividing input frames into one final low-frequency frame and at least one high-frequency frame by performing motion compensated temporal filtering on the input frames; and
encoding the final low-frequency frame and the at least one high-frequency frame;
wherein the dividing the input frames comprises:
generating the at least one high-frequency frame from a low-frequency frame of a current layer;
generating a virtual high-frequency frame using a restored frame of a lower layer; and
updating the low-frequency frame using a weighted mean of the high-frequency frames and the virtual high-frequency frame.

17. A video decoding method comprising:
restoring a final low-frequency frame and at least one high-frequency frame by decoding texture data included in an input bitstream; and
performing inverse-motion compensated temporal filtering on the final low-frequency frame and the at least one high-frequency frame using motion data included in the input bitstream;
wherein the at least one high-frequency frame is a high-frequency frame re-estimated in an encoder.

18. The video encoding method as set forth in claim 17, wherein the restoring the final low-frequency frame and the at least one high-frequency frame comprises:
decoding the input bitstream without loss;
inversely quantizing texture data of a result of the decoding; and
inversely transforming a result of the inverse quantizing.

19. The video encoding method as set forth in claim 17, wherein the performing the inverse-motion compensated temporal filtering comprises:
inversely updating a first low-frequency frame using a first high-frequency frame located at a same level as that of the first low-frequency frame; and
generating a second low-frequency frame by inversely predicting the first high-frequency frame using the inversely updated first low-frequency frame.

20. The video encoding method as set forth in claim 17, wherein the performing the inverse-motion compensated temporal filtering comprises:
inversely updating a first low-frequency frame using a first high-frequency frame located at a same level as that of the first low-frequency frame; and
generating a second low-frequency frame by inversely predicting the first high-frequency frame using the inversely updated first low-frequency frame;
wherein, if the first low-frequency frame is located at a location of the final low-frequency frame, the inversely updating the first low-frequency frame is not performed.

21. A video decoding method comprising:
restoring a final low-frequency frame and at least one high-frequency frame of a current layer by decoding texture data included in an input bitstream; and
performing inverse-motion compensated temporal filtering on the final low-frequency frame and the at least one high-frequency frame using motion data included in the input bitstream;
wherein the performing the inverse-motion compensated temporal filtering comprises:
generating a virtual high-frequency frame using a restored frame of a lower layer;
inversely updating a first low-frequency frame using the virtual high-frequency frame; and
restoring a second low-frequency frame by inversely predicting the restored high-frequency frame with reference to the updated first low-frequency frame.

22. The video encoding method as set forth in claim 21, wherein the restoring the final low-frequency frame and the at least one high-frequency frame comprises:
decoding the input bitstream without loss;
inversely quantizing texture data of a result of the decoding; and
inversely transforming a result of the inverse quantizing.

23. The video encoding method as set forth in claim 21, wherein the virtual high-frequency frame is a high-frequency frame of the restored lower layer frames.

24. The video encoding method as set forth in claim 21, wherein the generating the virtual high-frequency frame comprises:
restoring the low-frequency frame and high-frequency frame of the lower layer from the input bitstream;
restoring low-frequency frames of the lower layer by performing inverse motion compensated temporal filtering on the restored frames of the lower layer;
generating a predicted frame from the restored low-frequency frames of the lower layer; and
generating a virtual high-frequency frame by subtracting the predicted frame from a predetermined low-frequency frame of the current layer.

25. The video encoding method as set forth in claim 21, wherein the generating the virtual high-frequency frame comprises:
restoring the low-frequency frame and high-frequency frame of the lower layer from the input bitstream;
restoring low-frequency frames of a lower layer by performing inverse motion compensated temporal filtering on the restored frames of the lower layer;
generating a predicted frame for the second low-frequency frame using the first low-frequency frame; and
generating a virtual high-frequency frame by subtracting the generated predicted frame from a frame corresponding to the second low-frequency frame of the restored low-frequency frames of the lower layer.

26. A video encoder comprising:
means for dividing input frames into one final low-frequency frame and at least one high-frequency frame by performing motion compensated temporal filtering on the input frames;
means for encoding the final low-frequency frame and decoding the encoded final low-frequency frame;
means for re-estimating the at least one high-frequency frame using the decoded final low-frequency frame; and
means for encoding the re-estimated high-frequency frame.

27. A video encoder comprising:
means for dividing input frames into one final low-frequency frame and at least one high-frequency frame by performing motion compensated temporal filtering on the input frames; and
means for encoding the final low-frequency frame and the at least one high-frequency frame;
wherein the means for dividing the input frames comprises:
means for generating the at least one high-frequency frame from a low-frequency frame of a current layer;
means for generating a virtual high-frequency frame using a restored frame of a lower layer; and
means for updating the low-frequency frame using the virtual high-frequency frame.

28. A video encoder comprising:
means for dividing input frames into one final low-frequency frame and at least one high-frequency frame by performing motion compensated temporal filtering on the input frames; and
means for encoding the final low-frequency frame and the at least one high-frequency frame;
wherein the means for dividing the input frames comprises:
means for generating the at least one high-frequency frame from a low-frequency frame of a current layer;
means for generating a virtual high-frequency frame using a restored frame of a lower layer; and
means for updating the low-frequency frame using a weighted-mean of the high-frequency frames and the virtual high-frequency frame.

29. A video decoder comprising:
means for restoring a final low-frequency frame and at least one high-frequency frame by decoding texture data included in an input bitstream; and
means for performing inverse motion compensated temporal filtering on the final low-frequency frame and the at least one high-frequency frame using motion data included in the input bitstream;
wherein the high-frequency frames are high-frequency frames that are re-estimated in an encoder.

30. A video decoder comprising:
means for restoring a final low-frequency frame and at least one high-frequency frames of a current layer by decoding texture data included in an input bitstream; and
means for performing inverse-motion compensated temporal filtering on the final low-frequency frame and the at least one high-frequency frame using motion data included in the input bitstream;
wherein the means for the performing inverse-motion compensated temporal filtering comprises:
means for generating a virtual high-frequency frame using a restored frame of a lower layer;
means for inversely updating a first low-frequency frame using the virtual high-frequency frame; and
means for restoring a second low-frequency frame by inversely predicting the restored high-frequency frames with reference to the updated first low-frequency frame.
